(19) United States
(12) Patent Application Publication
(10) Pub. No.: US 2024/0020587 A1
(43) Pub. Date: Jan. 18, 2024

(54) INFORMATION PROCESSING APPARATUS, METHOD, AND NON-TRANSITORY COMPUTER READABLE MEDIUM

(71) Applicant: TOYOTA JIDOSHA KABUSHIKI KAISHA, Aichi-ken (JP)

(72) Inventors: Kai TANAKA, Kumamoto-shi (JP); Junpei OKAMOTO, Sayama-shi (JP); Makoto KINOSHITA, Tokyo-to (JP)

(21) Appl. No.: 18/349,960

(22) Filed: Jul. 11, 2023

(30) Foreign Application Priority Data
Jul. 12, 2022 (JP) 2022-112023

(51) Int. Cl. G06Q 10/02; G06Q 50/30

(52) U.S. Cl. CPC G06Q 10/02; G06Q 50/30

(57) ABSTRACT

An information processing apparatus including a controller, wherein the controller is configured to acquire an activity history, which is information indicating a history of places of stay and times of stay of a user of a terminal apparatus, extract at least one place of stay for which the time of stay indicated by the activity history exceeds a threshold, set the at least one place of stay as a first place of stay based on the time of stay at the at least one place of stay, and transmit, in a case in which it is determined that a current location of the user is the first place of stay and that the first place of stay is within a service area, an instruction to the terminal apparatus of the user to display a reservation button for an on-demand bus on a screen of the terminal apparatus.

### CROSS-REFERENCE TO RELATED APPLICATION

This application claims priority to Japanese Patent Application No. 2022-112023 filed on Jul. 12, 2022, the entire contents of which are incorporated herein by reference.

### TECHNICAL FIELD

The present disclosure relates to an information processing apparatus, a method, and a non-transitory computer readable medium.

### BACKGROUND

Technology has been developed for on-demand transportation systems, such as on-demand buses, in which an operation plan, including a travel route and operation schedule, is determined according to a user's wishes. For example, Patent Literature (PTL) 1 discloses technology for confirming users of on-demand buses.

### CITATION LIST

### Patent Literature

PTL 1: JP 2020-140265 A

### SUMMARY

In on-demand bus transportation systems, on-demand bus services are often provided exclusively to residents, commuters, or school commuters (hereinafter also “residents and the like”) in the service area. When a user does not provide information indicating the area of their home, workplace, or school (hereinafter “home or the like”), it cannot be determined whether the user is eligible to use an on-demand bus, making it difficult to identify an available on-demand bus for each user. Users have therefore needed to manually search for an on-demand bus available at their current location, requiring multiple screen transitions to complete the on-demand bus reservation. In this way, conventional technology related to on-demand transportation systems has not considered the question of facilitating on-demand bus reservations based on user activity and thus has room for improvement.

It would be helpful to improve technology related to on-demand transportation systems.

An information processing apparatus according to an embodiment of the present disclosure is an information processing apparatus including a controller, wherein
the controller is configured to
   acquire an activity history, which is information indicating a history of places of stay and times of stay of a user of a terminal apparatus,
   extract at least one place of stay for which the time of stay indicated by the activity history exceeds a threshold,
   set the at least one place of stay as a first place of stay based on the time of stay at the at least one place of stay, and
   transmit, in a case in which it is determined that a current location of the user is the first place of stay and that the first place of stay is within a service area, an instruction to the terminal apparatus to display a reservation button for an on-demand bus on a screen of the terminal apparatus.

A method according to an embodiment of the present disclosure is a method to be executed by an information processing apparatus, the method including:
acquiring an activity history, which is information indicating a history of places of stay and times of stay of a user of a terminal apparatus;
extracting at least one place of stay for which the time of stay indicated by the activity history exceeds a threshold;
setting the at least one place of stay as a first place of stay based on the time of stay at the at least one place of stay; and
transmitting, in a case in which it is determined that a current location of the user is the first place of stay and that the first place of stay is within a service area, an instruction to the terminal apparatus to display a reservation button for an on-demand bus on a screen of the terminal apparatus.

A computer readable non-transitory medium according to an embodiment of the present disclosure is a computer readable non-transitory medium storing a program configured to cause an information processing apparatus to:
acquire an activity history, which is information indicating a history of places of stay and times of stay of a user of a terminal apparatus;
extract at least one place of stay for which the time of stay indicated by the activity history exceeds a threshold;
set the at least one place of stay as a first place of stay based on the time of stay at the at least one place of stay; and
transmit, in a case in which it is determined that a current location of the user is the first place of stay and that the first place of stay is within a service area, an instruction to the terminal apparatus to display a reservation button for an on-demand bus on a screen of the terminal apparatus.

According to an embodiment of the present disclosure, technology related to on-demand transportation systems is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of an information processing apparatus;

FIG. 4 is a flowchart illustrating operations of the information processing apparatus; and

FIG. 5 is a diagram illustrating a display example of a reservation button for an on-demand bus on a terminal apparatus.

### DETAILED DESCRIPTION

Hereinafter, an embodiment of the present disclosure will be described.

### Outline of Embodiment

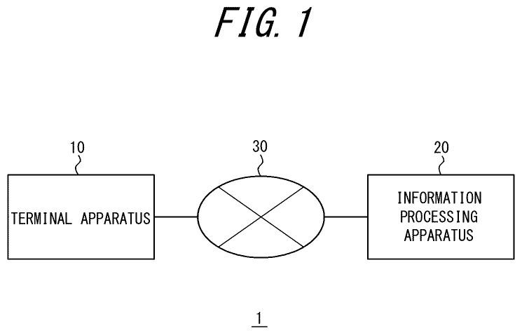

An outline of a system 1 according to an embodiment of the present disclosure will be described with reference to FIG. 1. The system 1 includes a terminal apparatus 10 and an information processing apparatus 20. The terminal apparatus 10 and the information processing apparatus 20 are communicably connected to a network 30 including, for example, the Internet, a mobile communication network, or the like.

The terminal apparatus 10 is, for example, a mobile device such as a mobile phone, a smartphone, or a tablet. The user can operate the terminal apparatus 10 to make a reservation for an on-demand bus. The number of terminal apparatuses 10 included in the system 1 can be freely determined.

The information processing apparatus 20 is, for example, a computer such as a server apparatus. The information processing apparatus 20 can communicate with the terminal apparatus 10 via the network 30.

First, an outline of the present embodiment will be described, and details thereof will be described later. The information processing apparatus acquires an activity history, which is information indicating places of stay and times of stay of the user of the terminal apparatus 10. The information processing apparatus 20 extracts at least one place of stay for which the time of stay indicated by the activity history exceeds a threshold. The information processing apparatus 20 sets the at least one place of stay as a first place of stay based on the time of stay at the at least one place of stay. The information processing apparatus 20 transmits, in a case in which it is determined that the current location of the user is the first place of stay and that the first place of stay is within a service area, an instruction to the terminal apparatus 10 of the user to display a reservation button for an on-demand bus on the screen of the terminal apparatus 10.

According to the present embodiment, it is thus determined whether the user is in the service area based on the activity history and current location of the user of the terminal apparatus 10, i.e., the user's activity. According to the result of the determination, it is then determined whether to display the reservation button for the on-demand bus (“reservation button”) on the screen of the user's terminal apparatus 10. For example, on an application that provides transportation guidance information (“transportation guidance application”), the on-demand buses available at the current location can therefore be identified for each user and presented to the user without requiring the user to input an area such as the user's home. Users will be able to immediately reserve an on-demand bus that is estimated to be available at their current location by simply pressing the reservation button displayed on the transportation guidance application, for example. Accordingly, technology related to on-demand transportation systems is improved by facilitation of on-demand bus reservations based on user activity.

Next, configurations of the system 1 will be described in detail.

<Terminal Apparatus Configuration>

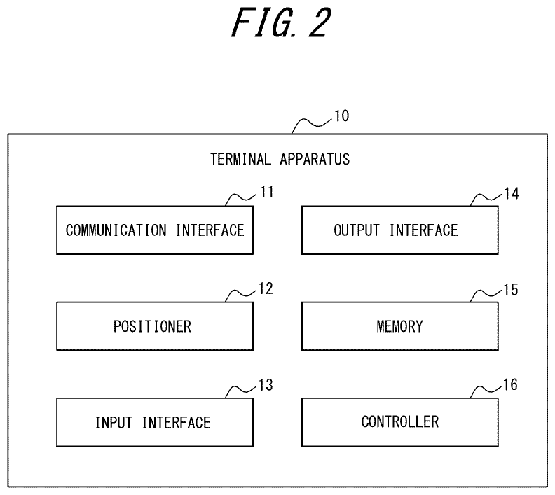

As illustrated in FIG. 2, the terminal apparatus 10 includes a communication interface 11, a positioner 12, an input interface 13, an output interface 14, a memory 15, and a controller 16.

The communication interface 11 includes at least one communication interface for connecting to the network 30. The communication interface is, for example, compliant with mobile communication standards such as the 4th generation (4G) standard or the 5th generation (5G) standard, but these examples are not limiting. In the present embodiment, the terminal apparatus 10 communicates with the information processing apparatus 20 via the communication interface 11 and the network 30.

The positioner 12 includes at least one device for acquiring positional information for the terminal apparatus 10. Specifically, the positioner 12 includes a receiver corresponding to the Global Positioning System (GPS), for example, but is not limited to this and may include a receiver corresponding to any satellite positioning system.

The input interface 13 includes at least one interface for input. The interface for input is, for example, a physical key, a capacitive key, a pointing device, or a touch screen integrally provided with a display. The input interface 13 accepts an operation for inputting data to be used for the operations of the terminal apparatus 10. The input interface 13 may be connected to the terminal apparatus 10 as an external input device, instead of being included in the terminal apparatus 10. As an interface for connection, for example, an interface compliant with a standard such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The output interface 14 may include at least one output device for outputting information to notify the user of the information. The output device is a display for outputting information as images or video, a speaker for outputting information as audio, or the like, for example, but is not limited to these. The display is, for example, a liquid crystal display (LCD) or an organic electro luminescent (EL) display. The output interface 14 may include an interface for connecting to an external output device.

The memory 15 includes one or more memories. The memories are semiconductor memories, magnetic memories, optical memories, or the like, for example, but are not limited to these. The memories included in the memory 15 may each function as, for example, a main memory, an auxiliary memory, or a cache memory. The memory 15 stores any information to be used for operations of the terminal apparatus 10. For example, the memory 15 may store a system program, an application program, embedded software, and the like. The information stored in the memory 15 may be updated with, for example, information acquired from the network 30 via the communication interface 11.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 16 controls the operations of the entire terminal apparatus 10.

<Information Processing Apparatus Configuration>

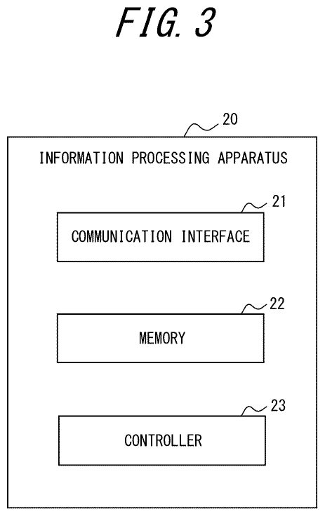

As illustrated in FIG. 3, the information processing apparatus 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the terminal apparatus 10 via the communication interface 21 and the network 30.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, map information, and the like. The information stored in the memory 22 may be updated with, for example, information acquired from the network 30 via the communication interface 21.

The controller 23 includes at least one processor, at least one programmable circuit, at least one dedicated circuit, or a combination of these. The controller 23 controls the operations of the entire information processing apparatus 20.

<Flow of Operations of Information Processing Apparatus>

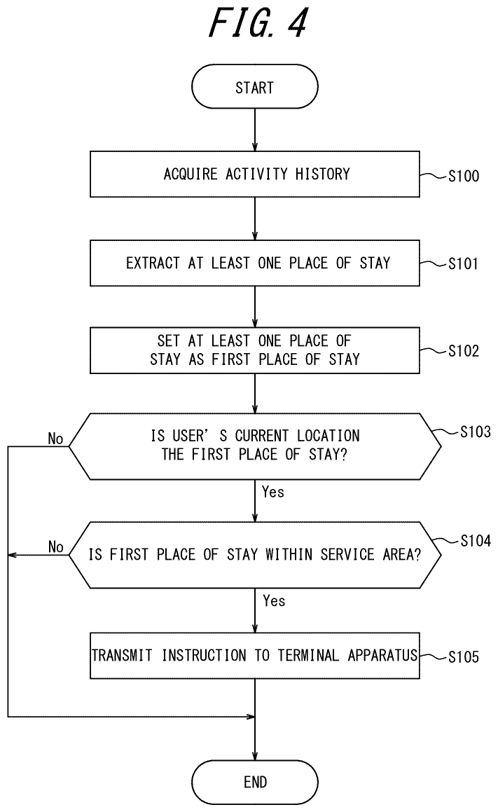

Operations of the information processing apparatus 20 according to the present embodiment will be described with reference to FIG. 4. The operations in FIG. 4 correspond to a method according to the present embodiment. The operations in FIG. 4 are performed repeatedly, for example, at a predetermined period. The predetermined period can be freely determined.

Step S100: the controller 23 of the information processing apparatus acquires an activity history, which is information indicating places of stay and times of stay of the user of the terminal apparatus 10.

Any method can be used to acquire the activity history. For example, the controller 23 receives the coordinates of the terminal apparatus 10, acquired via the positioner 12 of the terminal apparatus 10, and corresponding timestamps from the communication interface 11 of the terminal apparatus 10 via the network 30 and the communication interface 21. These coordinates and timestamps may include not only current information but also historical information recorded in the memory 15 of the terminal apparatus 10, for example. The controller 23 identifies the received coordinates as the user's place of stay and calculates the user's time of stay at each place of stay from the corresponding timestamps. The controller 23 stores information (such as a table) associating the identified place of stay and the calculated time of stay as activity history in a database stored in the memory 22. The controller 23 can acquire the activity history by reading the activity history from the memory 22 each time the operations in FIG. 4 are executed.

Step S101: the controller 23 extracts at least one place of stay for which the time of stay indicated by the activity history acquired in step S100 exceeds a threshold.

Any appropriate method can be adopted to extract at least one place of stay. For example, the controller 23 can extract at least one place of stay for which the time of stay exceeds a threshold (such as 3 hours) by referring to the time of stay at each place of stay as indicated in the activity history read from the memory 22.

Step S102: the controller 23 sets the at least one place of stay, extracted in step S101, as a first place of stay based on the time of stay at the at least one place of stay.

Any appropriate method can be adopted to set the first place of stay. For example, the controller 23 may set the at least one place of stay as the first place of stay in a case in which it is determined that the time slot to which the time of stay at the at least one place of stay belongs is nighttime. For example, assume that in step S101, a place of stay A is extracted as a place of stay for which the time of stay exceeds a threshold (such as 3 hours). In this case, the controller 23 determines whether the time slot to which the time of stay at the place of stay A belongs is during daytime (for example, from 9:00 until 18:00) or nighttime (for example, from 18:00 until 6:00 the next day). In a case in which the time slot to which the time of stay belongs is nighttime rather than daytime, the place of stay A is more likely to be the user's home, where the user sleeps. By estimating the first place of stay set in this way as the user's home, the controller 23 can perform the “service area determination” in step S104, described below, without requiring the user to input his home or other region.

Step S103: the controller 23 determines whether the user's current location is the first place of stay set in step S102. In a case in which the user's current location is determined to be the first place of stay (S103: Yes), the process advances to step S104. Conversely, in a case in which the user's current location is determined not to be the first place of stay (step S103: No), the process ends.

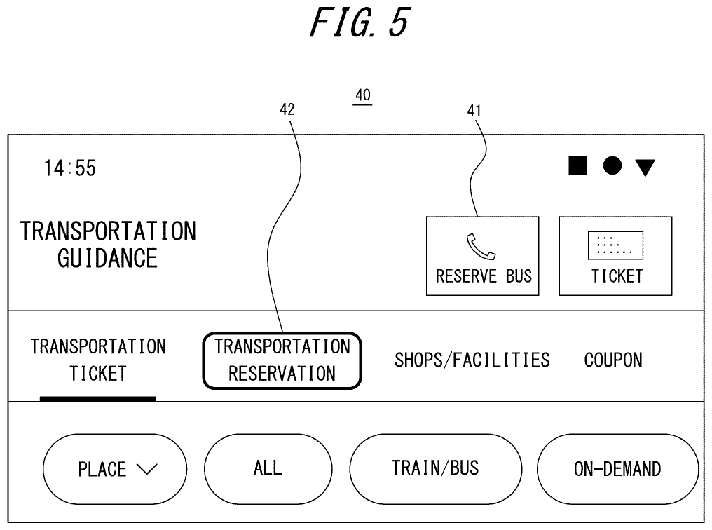

Specifically, the controller 23 receives the coordinates of the terminal apparatus 10, acquired via the positioner 12 of the terminal apparatus 10, from the communication interface 11 of the terminal apparatus 10 via the network and the communication interface 21. The controller 23 identifies the current coordinates of the terminal apparatus 10 received via the communication interface 21 as the user's current location. For example, the user's current location may be identified as the coordinates at the time the user operates the smartphone serving as the terminal apparatus 10 and launches a transportation guidance application such as the one illustrated in FIG. 5. FIG. 5 illustrates a top screen 40 that is displayed when the transportation guidance application is launched. The controller 23 then compares the user's identified current location with the first place of stay set in step S102. In a case in which it is determined, as a result of the comparison, that the coordinates of the user's current location and the first place of stay are equivalent, the controller 23 determines that the user's current location is the first place of stay. The coordinates of the user's current location and those of the first place of stay do not necessarily need to match exactly and may be determined to be equivalent upon being within a predetermined error range. However, the identification of the user's current location is not limited to these examples, and any appropriate method can be adopted.

Step S104: the controller 23 determines whether the first place of stay set in step S102 is within the service area. This determination is also referred to below as the “service area determination”. In a case in which the first place of stay is determined to be within the service area (S104: Yes), the process advances to step S105. On the other hand, in a case in which the first place of stay is determined not to be within the service area (step S104: No), the process ends.

Any method can be adopted for the service area determination. For example, the controller 23 may acquire information indicating the service area of the corresponding on-demand bus (such as an operation plan) from the on-demand bus operator. The controller 23 may determine whether there is an on-demand bus that includes the first place of stay in its service area by comparing the coordinates of the service area indicated by the acquired information with the coordinates of the first place of stay. In a case in which it is determined that there is at least one on-demand bus that includes the first place of stay in its service area, the controller 23 can determine that the first place of stay is within the service area of that on-demand bus. For example, assume that user X is a resident of city Y, that there is an on-demand bus BY that provides service exclusively to residents and the like of city Y, and that there is an on-demand bus BZ that provides service exclusively to residents and the like of city Z. In this case, the controller 23 acquires information indicating the corresponding on-demand bus service areas from a plurality of on-demand bus operators, including the operators of the on-demand bus BY and the on-demand bus BZ. By comparing the coordinates of the service area of each on-demand bus indicated by the acquired information with the coordinates of the first place of stay, the controller 23 identifies the on-demand bus BY whose service area includes city Y, which is the first place of stay (home in the present example) of user X. In this case, the controller 23 determines that the first place of stay is within the service area.

Step S105: in a case in which it is determined that the current location of the user is the first place of stay (step S103: Yes) and that the first place of stay is within the service area (step S104: Yes), the controller 23 transmits an instruction to the terminal apparatus 10 of the user to display a reservation button for an on-demand bus on the screen of the terminal apparatus 10. The process then ends.

Specifically, the controller 23 transmits an instruction to the communication interface 11 of the terminal apparatus 10, via the network 30 and the communication interface 21, to display a reservation button for an on-demand bus on the screen of the user's terminal apparatus 10. The controller 16 of the terminal apparatus 10 displays the reservation button for the on-demand bus indicated in the instruction received via the communication interface 21 on the screen of the display serving as the output interface 14 of the terminal apparatus 10. Any appropriate method can be adopted to display the reservation button for the on-demand bus. For example, the reservation button for the on-demand bus may be displayed on the screen of the user's terminal apparatus 10 by displaying a reservation button 41 on the top screen 40 of a transportation guidance application, such as the one illustrated in FIG. 5, launched by the user operating a smartphone serving as the terminal apparatus 10.

In a case in which the reservation button for the on-demand bus is not displayed, as in the past, the user needs to press a transportation reservation button 42 on a transportation guidance application, such as the one illustrated in FIG. 5, to search for an on-demand bus and transition through a plurality of screens before completing the on-demand bus reservation. By contrast, according to the present embodiment, users can reserve an on-demand bus that is estimated to be available at their current location by simply pressing the reservation button 41 displayed on the top screen 40, as illustrated in FIG. 5. Displaying the reservation button in an easily accessible location, such as the top screen of a transportation guidance application, thereby facilitates reservation of an on-demand bus.

As described above, the information processing apparatus 20 according to the present embodiment acquires an activity history, which is information indicating places of stay and times of stay of the user of the terminal apparatus 10. The information processing apparatus 20 extracts at least one place of stay for which the time of stay indicated by the activity history exceeds a threshold. The information processing apparatus 20 sets the at least one place of stay as a first place of stay based on the time of stay at the at least one place of stay. The information processing apparatus 20 transmits, in a case in which it is determined that the current location of the user is the first place of stay and that the first place of stay is within a service area, an instruction to the terminal apparatus 10 of the user to display a reservation button for an on-demand bus on the screen of the terminal apparatus 10.

According to this configuration, the service area determination can be made based on the activity history and current location of the user of the terminal apparatus 10, i.e., the user's activity. Depending on the result of the determination, it can be determined whether to display the reservation button on the user's terminal apparatus 10. For example, on a transportation guidance application, the on-demand buses available at the current location can therefore be identified for each user and presented to the user without requiring the user to input an area such as the user's home. Users will be able to immediately reserve an on-demand bus that is estimated to be available at their current location by simply pressing the reservation button 41 displayed on the top screen 40 of a transportation guidance application such as the one illustrated in FIG. 5. Accordingly, technology related to on-demand transportation systems is improved by facilitation of on-demand bus reservations based on user activity.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in a variation of the present embodiment, the controller 23 may transmit the instruction, to the terminal apparatus 10, to display a reservation button for an on-demand bus on the screen of the user's terminal apparatus 10 in a case in which it is determined that the user's current location is a second place of stay different from the first place of stay (a second place of stay for which the time of stay exceeds the threshold) and that the second place stay is within the service area. For example, assume that in step S103 above, it is determined that the user's current location is not the first place of stay (home in the above-described example) but rather the second place of stay (such as the workplace), and that the second place of stay is within the service area. In this case, the controller 23 transmits the instruction to the terminal apparatus 10. As in the present embodiment, this enables a reservation button for an on-demand bus to be displayed on a transportation guidance application such as the one illustrated in FIG. 5 in a case in which an on-demand bus is also available at the location of the user's workplace, for example.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the terminal apparatus 10 can also be implemented.

For example, an embodiment in which a general purpose computer functions as the information processing apparatus 20 according to the above embodiment can also be implemented. Specifically, a program in which processes for realizing the functions of the information processing apparatus according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller, wherein
the controller is configured to
acquire an activity history, which is information indicating a history of places of stay and times of stay of a user of a terminal apparatus,
extract at least one place of stay for which the time of stay indicated by the activity history exceeds a threshold,
set the at least one place of stay as a first place of stay based on the time of stay at the at least one place of stay, and
transmit, in a case in which it is determined that a current location of the user is the first place of stay and that the first place of stay is within a service area, an instruction to the terminal apparatus to display a reservation button for an on-demand bus on a screen of the terminal apparatus.

2. The information processing apparatus according to claim 1, wherein the controller is configured to set the at least one place of stay a s the first place of stay in a case in which it is determined that a time slot to which the time of stay at the at least one place of stay belongs is nighttime.

3. The information processing apparatus according to claim 1, wherein the controller is configured to transmit the instruction to the terminal apparatus in a case in which it is determined that the current location of the user is a second place of stay different from the first place of stay and that the second place of stay is within the service area.

4. A method to be executed by an information processing apparatus, the method comprising:
acquiring an activity history, which is information indicating a history of places of stay and times of stay of a user of a terminal apparatus;
extracting at least one place of stay for which the time of stay indicated by the activity history exceeds a threshold;
setting the at least one place of stay as a first place of stay based on the time of stay at the at least one place of stay; and
transmitting, in a case in which it is determined that a current location of the user is the first place of stay and that the first place of stay is within a service area, an instruction to the terminal apparatus to display a reservation button for an on-demand bus on a screen of the terminal apparatus.

5. A computer readable non-transitory medium storing a program configured to cause an information processing apparatus to:
acquire an activity history, which is information indicating a history of places of stay and times of stay of a user of a terminal apparatus;
extract at least one place of stay for which the time of stay indicated by the activity history exceeds a threshold;
set the at least one place of stay as a first place of stay based on the time of stay at the at least one place of stay; and
transmit, in a case in which it is determined that a current location of the user is the first place of stay and that the first place of stay is within a service area, an instruction to the terminal apparatus to display a reservation button for an on-demand bus on a screen of the terminal apparatus.
